(19) United States
(12) Patent Application Publication
(10) Pub. No.: US 2015/0362757 A1
(43) Pub. Date: Dec. 17, 2015

(54) COLORED CONTACT LENS PROVIDED WITH BLUE LIGHT FILTERING AND ANTI-UV FUNCTIONS

(71) Applicant: Sun-Chia Fu, TAIPEI COUNTY (TW)

(72) Inventor: Sun-Chia Fu, TAIPEI COUNTY (TW)

(73) Assignee: SMART PERFORMER CO., LTD., TAIPEI COUNTY (TW)

(21) Appl. No.: 14/562,700

(22) Filed: Dec. 6, 2014

(30) Foreign Application Priority Data
Jun. 12, 2014 (TW) 103210341

(51) Int. Cl. G02C 7/10; G02C 7/04

(52) U.S. Cl. CPC G02C 7/104; G02C 7/04; G02C 7/108

(57) ABSTRACT

A colored contact lens provided with blue light filtering and anti-UV functions of the present invention is a coated contact lens formed from three layers, in which a coloring agent of a middle layer is cured onto a lower layer lens, and the upper layer lens contains an UV (ultraviolet)-light absorber and a blue light filming agent. Accordingly, apart from providing a colored contact lens, the contact lens further achieves the multiple effectiveness of anti-UV and blue light filtering.

### BACKGROUND OF THE INVENTION

(a) Field of the Invention

The present invention relates to a colored contact lens provided with blue light filtering and anti-UV functions, and more particularly to providing a contact lens which is also provided with the function to filter out blue light and possesses anti-UV (ultraviolet) capability.

(b) Description of the Prior Art

General sunglasses are able to filter out UV (ultraviolet) rays from sunlight, and also have a slight blue light filtering effect of approximately 10%. However, in general, people do not wear sunglasses indoors when using a computer because it would be too dark to see the computer screen clearly. Hence, people only normally wear sunglasses outdoors and wear blue light filter glasses indoors. And glasses which claim to have color changing transitions lenses mainly comprise the integration of a UV filter function into short sighted prescription lenses, but do not provide a blue light filtering effect. Moreover, the screens of general mobile phones, computers, and tablet computers all emit blue light. Blue light is the strongest color in visible light, and long-term, excessive direct viewing of blue light will injure the macula portion of the eyes and retinal cells, causing lesions. Furthermore, blue light easily causes the eyes to feel tired and sore. As a rule, a person should avoid prolonged staring at a computer or cell phone screen, and rest for 5-10 minutes at least every 50 minutes by consciously blinking the eyes, looking into the distance, or getting up and moving around, if work requires a person to stare at electronic screens for long periods of time, then the person should wear blue light filter glasses. In addition, blue light filter glasses or sunglasses commonly seen on the market all use traditional spectacle lenses, and currently there is still only one type of colored contact lenses provided with blue light filtering and anti-UV functions.

### SUMMARY OF THE INVENTION

Accordingly, the primary object of the present invention is to provide a colored contact lens, with the lens having blue light filtering and anti-UV (ultraviolet) functions, as well as providing the colored contact lens with a color pattern.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a perspective view of the colored contact lenses of the present invention.

FIG. 2 shows a schematic view of the first procedure for making colored contact lenses of the present invention.

FIG. 3 shows a schematic view of the second procedure for making colored contact lenses of the present invention.

FIG. 4 shows a schematic view of the third procedure for making colored contact lenses of the present invention.

### DETAILED DESCRIPTION OF THE PREFERRED

### Embodiments

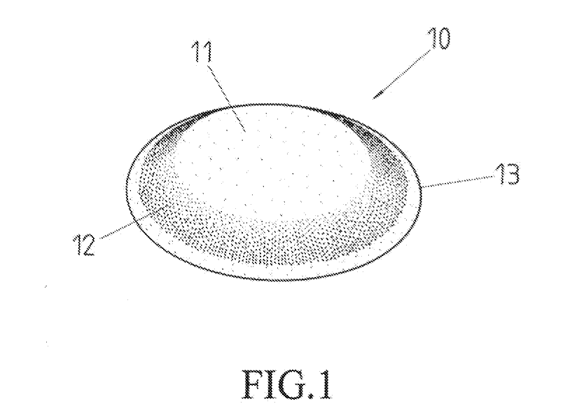

Referring to FIG. 1, which shows a schematic view of a contact lens 10 of the present invention, wherein the contact lens 10 is a three-layer coated device. An upper layer lens 11 is a soft translucent (such as a faint tinting) structure, a lower layer lens 13 is a soft transparent structure, and a middle layer is a coloring agent 12. A dotted distribution of the coloring agent 12 over the middle layer forms rings of different depth. Accordingly, using such a dotted distribution on the middle layer creates a natural beautiful effect for the wearer.

The following is a general description of the process for making contact lenses:

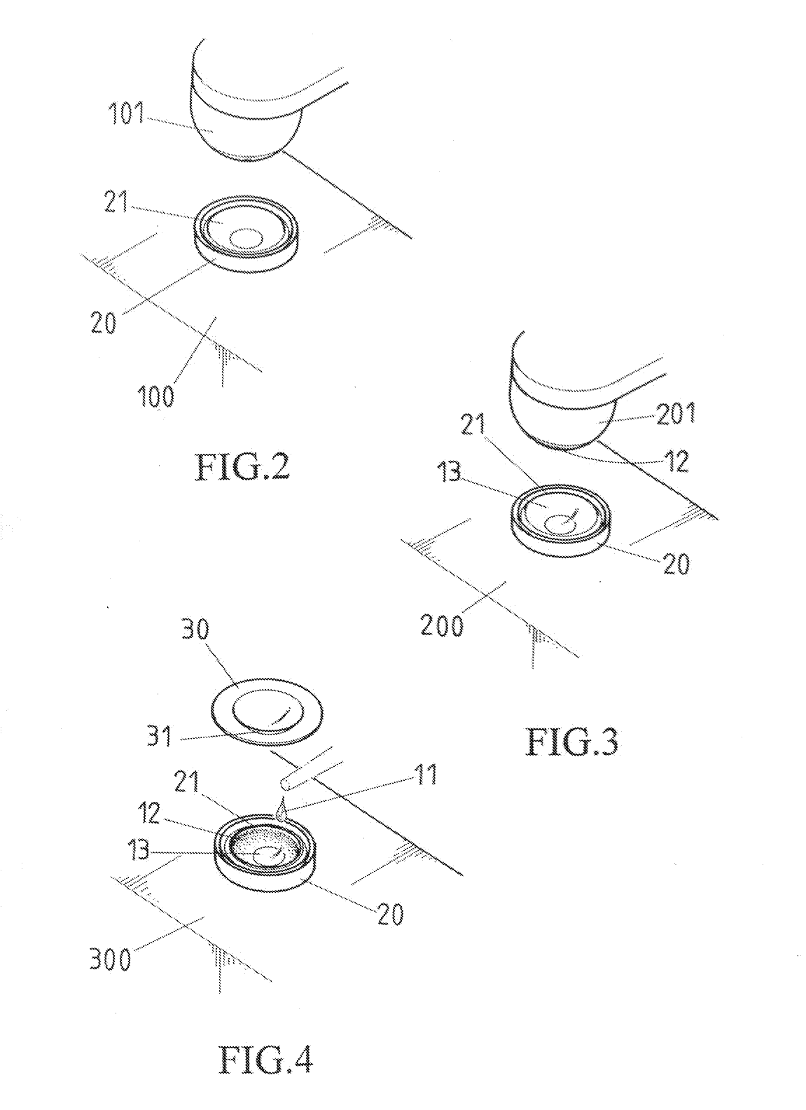

First procedure: Referring to FIG. 2, a lower molded lens 20 is first placed on a first template 100. The top of the lower molded lens 20 is provided with a circular recess 21, and a first printing pad 101 on a mold machine transfers material of the lower layer lens 13 to the interior of the recess 21 of the lower molded lens 20. After which, curing and shaping is carried in a reaction tank.

Second procedure: Referring to FIG. 3, the lower molded lens 20 containing the cured lower layer lens 13 is placed on a second template 200. A second printing pad 201 of the mold machine coats the coloring agent 12 on the cured lower layer lens 13 to form a dotted annular distribution over the lower layer lens 13. The coloring agent 12 is dried using a reaction tank and fixedly positioned.

Third procedure: Referring to FIG. 4, the lower molded lens 20 containing the cured lower layer lens 13 coated with the coloring agent 12 is placed on a third template 300. Drops of the upper layer lens 11 having a prescription strength and containing an UV (ultraviolet)-light absorber and blue light filtering filming agent are dripped into the cured lower layer lens 13, which at the same time coats the coloring agent 12. Moreover, an upper molded lens 30 is used to cover the lower molded lens 20. Wherein a circular protruding piece 31 on the underside of the upper molded lens 30 covers the interior of the recess 21 of the lower molded lens 20, while at the same time covers the upper portion of the uncured and unshaped upper layer lens 11. Adhesive dispensing, pressing together, reacting, and demolding is then carried out on the still unshaped contact lens assembly assembled from the aforementioned upper layer lens 11, the the coloring agent 12, and the lower layer lens 13 using a machine for manufacturing spectacles, which is then finally washed by passing through a hydration equipment to form the contact lens 10 as shown in FIG. 1. The UV absorber (ultraviolet screening agent) in the upper layer lens 11 of the contact lens 10 is able to absorb light in the ultraviolet spectrum, and the blue light filtering filming agent is provided with blue light filtering effectiveness. The aforementioned contact lens 10 is a lens directly cast in a mold, wherein a lens forming single body monomer mixture is placed in the mold and exposed to UV radiation and blue light to effect coating and polymer curing thereof.

In conclusion, according to the above description of the embodiments, the present invention is assuredly an innovative contact lens, which apart from providing a colored contact lens having prescription strength, the colored contact lens of the present invention is further provided with anti-UV and blue light filtering functions.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A colored contact lens provided with blue light filtering and anti-UV functions, wherein a coated contact lens is assembled from an upper layer lens, a middle layer, and a lower layer lens; the upper layer lens is a soft translucent structure, the lower layer lens is a soft transparent structure, and the middle layer is a coloring agent, wherein the coloring agent is cured on the lower layer lens; and the upper layer lens contains an UV (ultraviolet)-light absorber and a blue light filming agent.
